(19) United States
(12) Patent Application Publication
(10) Pub. No.: US 2015/0371769 A1
(43) Pub. Date: Dec. 24, 2015

(54) STATIONARY INDUCTION DEVICE

(71) Applicant: MITSUBISHI ELECTRIC CORPORATION, Chiyoda-ku, Tokyo (JP)

(72) Inventors: Takeshi IMURA, Chiyoda-ku (JP); Tetsuya MATSUDA, Chiyoda-ku (JP)

(73) Assignee: MITSUBISHI ELECTRIC CORPORATION, Chiyoda-ku, Tokyo (JP)

(21) Appl. No.: 14/765,651

(22) PCT Filed: Apr. 30, 2014
(86) PCT No.: PCT/JP2014/061948

§ 371 Date: Aug. 4, 2015

(30) Foreign Application Priority Data
May 13, 2013 (JP) 2013-101022

(51) Int. Cl. H01F 27/36

(52) U.S. Cl. CPC H01F 27/365

(57) ABSTRACT

A stationary induction device including a tank, a core which is housed in the tank, a winding which is housed in the tank and wound around the core, a plurality of metal magnets which are fixed on an inner wall of the tank and configured to form a magnetic shield for shielding a leakage flux generated from the winding, and at least one retaining plate which is joined to the inner wall of the tank and the plurality of metal magnets so as to fix the plurality of metal magnets on the inner wall of the tank. Among the plurality of metal magnets, the metal magnets adjacent to each other are connected to each other by one retaining plate only.

### TECHNICAL FIELD

The present invention relates to a stationary induction device, and in particular, relates to a stationary induction device such as a transformer and a reactor.

### BACKGROUND ART

As a prior art, Japanese Patent Laying-Open No. 7-211558 (PTD 1) discloses a structure of a magnetic shield disposed on an inner wall or the like of a tank of a transformer. In the magnetic shield disclosed in PTD 1, a plurality of magnetic shields are fixed in the tank through the intermediary of a plurality of mounting plates. As illustrated in FIG. 2 of PTD 1, three magnetic shields are fixed through the intermediary of four mounting plates.

### CITATION LIST

### Patent Document

### PTD 1: Japanese Patent Laying-Open No. 7-211558

### SUMMARY OF INVENTION

### Technical Problem

In the magnetic shield disclosed in PTD 1, the magnetic shields adjacent to each other are joined by a plurality of retaining plates. Therefore, in the case where the magnetic flux becomes saturated in the magnetic shields and thereby penetrates the magnetic shields, the magnetic flux penetrates through a loop section formed by the adjacent magnetic shields and the plurality of retaining plates and generates an eddy current flowing in the loop section. Accordingly, the magnetic shield is overheated locally by the eddy current flowing in the loop section.

The present invention has been made in view of the aforementioned problems, and an object thereof is to provide a stationary induction device capable of preventing a magnetic shield from being overheated locally by an eddy current flowing therein.

### Solution to Problem

The stationary induction device according to the present invention is provided with a tank, a core which is housed in the tank, a winding which is housed in the tank and wound around the core, a plurality of metal magnets which are fixed on an inner wall of the tank and configured to form a magnetic shield for shielding a leakage flux generated from the winding, and at least one retaining plate which is joined to the inner wall of the tank and the plurality of metal magnets so as to fix the plurality of metal magnets on the inner wall of the tank. Among the plurality of metal magnets, the metal magnets adjacent to each other being connected to each other by one retaining plate only.

### Advantageous Effects of Invention

According to the present invention, it is possible to prevent a magnetic shield from being overheated locally by an eddy current flowing therein.

### BRIEF DESCRIPTION OF DRAWINGS

FIG. 1 is a cross-sectional view partially illustrating a structure of a stationary induction device according to a first embodiment of the present invention,

FIG. 2 is a view illustrating the stationary induction device of FIG. 1 observed from the direction of arrow II,

FIG. 3 is a perspective view schematically illustrating a leakage flux penetrating the magnetic shield in FIG. 2,

FIG. 4 is a perspective view schematically illustrating a leakage flux penetrating a magnetic shield for a stationary induction device according to a second embodiment of the present invention,

FIG. 5 is an inner side view illustrating a structure of a magnetic shield for a stationary induction device according to a third embodiment of the present invention.

FIG. 6 is a perspective view schematically illustrating a leakage flux penetrating a magnetic shield for a stationary induction device according to a fourth embodiment of the present invention,

FIG. 7 is a perspective view schematically illustrating a leakage flux penetrating a magnetic shield for a stationary induction device according to a fifth embodiment of the present invention, and

FIG. 8 is a side view illustrating an inner structure of a magnetic shield for a stationary induction device according to a sixth embodiment of the present invention.

### DESCRIPTION OF EMBODIMENTS

Hereinafter, a stationary induction device according to a first embodiment of the present invention will be described with reference to the accompanying drawings. In the following description of embodiments, the same or equivalent portions in the drawings will be denoted by the same reference signs and the description thereof will not be repeated.

### First Embodiment

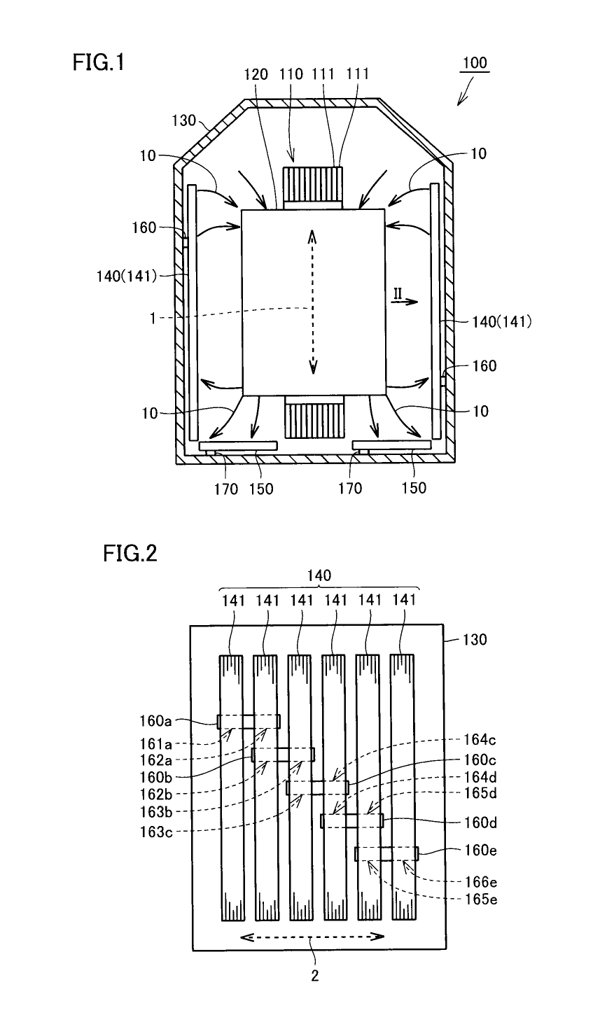

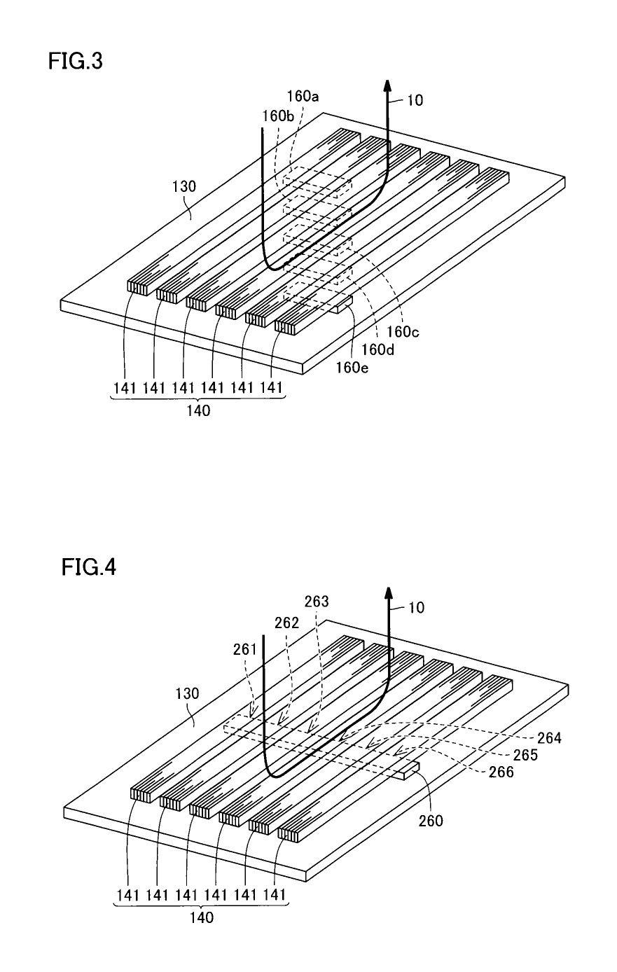

FIG. 1 is a partial cross-sectional view illustrating the structure of a stationary induction device according to the first embodiment of the present invention. FIG. 2 is a view illustrating the stationary induction device of FIG. 1 observed from the direction of arrow II. FIG. 3 is a perspective view schematically illustrating a leakage flux penetrating the magnetic shield in FIG. 2. FIG. 1 illustrates a core 110 and a tank 130 only in cross section. The leakage flux illustrated in FIG. 3 is merely an example.

As illustrated in FIGS. 1 to 3, a stationary induction device 100 according to the first embodiment of the present invention includes tank 130, core 110 housed in tank 130, and a winding 120 which is housed in tank 130 and wound around core 110. Core 110 is formed by stacking a plurality of magnetic steel plates 111, and in side view, has a rectangular outer shape having an opening in the center.

Stationary induction device 100 further includes a plurality of metal magnets 141 which extend along an axial direction 1 of winding 120, are fixed on an inner wall of tank 130 side by side along a direction 2 perpendicular to axial direction 1, and are configured to form a first magnetic shield 140 for shielding a leakage flux generated from winding 120, and at least one first retaining plate 160 which is joined to the inner wall of tank 130 and the plurality of metal magnets 141 so as to fix the plurality of metal magnets 141 on the inner wall of tank 130. First magnetic shield 140 is provided on each of the four inner walls of tank 130.

In the present embodiment, as illustrated in FIGS. 2 and 3, six metal magnets 141 are fixed on the inner wall of tank 130 through five pieces of first retaining plates 160. However, the number of metal magnets 141 and first retaining plates is not limited thereto. For example, a plurality of metal magnets 141 may be fixed on the inner wall of tank 130 through at least one first retaining plates 160.

Stationary induction device 100 further includes a second magnetic shield 150 which is fixed on the bottom of tank 130 through a second retaining plate 170 for shielding the leakage flux generated from winding 120. Second magnetic shield 150 is formed from a plurality of metal magnets, each of which is only different from metal magnet 141 in the extending direction and the length. Second retaining plate 170 has the same structure as first retaining plate 160. In planar view, second magnetic shields 150 are disposed in pair sandwiching core 110 therebetween. It should be noted that second magnetic shield 150 and second retaining plate 170 are optional.

Tank 130 is formed from structural rolled steel such as SS steel (Japanese Industrial Standards) or SM steel (Japanese Industrial Standards).

As illustrated in FIG. 1, in the case where leakage flux 10 generated from winding 120 penetrates the inner wall of tank 130, the inner wall of tank 130 becomes a path for an eddy current to flow therein. When the path in which the eddy current is flowing is large, the amount of leakage flux 10 interlinking with the path will become great, which makes the eddy current flowing in the path excessively large.

When the excessively large eddy current flows in the inner wall of tank 130, local heat will be generated at a portion of the inner wall of tank 130 where the eddy current flows. In the case where an insulator is disposed in the vicinity of the locally heated portion, there is a possibility that the insulator may be heated to deteriorate or even burn. In the case where an insulating oil is present in the vicinity of the locally heated portion, the insulating oil may be heated to decompose. When the insulating oil is heated to decompose, it releases nonflammable gas such as oxygen gas, nitrogen gas or carbon dioxide gas, or inflammable gas such as nitrogen monoxide gas, hydrogen gas, methane or propane gas, and these gases may be main factors to cause dielectric breakdown in the insulating oil.

As mentioned in the above, in order to suppress the flow of the excessively large eddy current in the inner wall of tank 130, conventionally, the magnetic shield as described in PTD 1 are provided. Hereinafter, the problems of these conventional magnetic shields will be described in detail.

A general magnetic shield of prior art is obtained by stacking a plurality of magnetic steel sheets, each of which has a magnetic permeability higher than that of the material constituting tank 130. Each magnetic steel sheet is of a strip shape and has an insulating layer provided on both main surfaces. Therefore, the plurality of stacked magnetic steel plates are insulated from each other.

The plurality of magnetic steel plates are sandwiched by two pinching plates disposed on both sides along the stacking direction of the magnetic steel sheets. Each pinching plate is welded to each of a plurality of retaining plates disposed in such a manner that each extends in the stacking direction of the magnetic steel sheets. The pinching plates and the retaining plates each is formed from a strip-shaped metal sheet. Thus, in the general magnetic shield of prior art, the plurality of magnetic steel sheets are sandwiched between two pinching plates which are joined together by a plurality of retaining plates to form an integral unit. Each of the plurality of retaining plates is joined to the plurality of magnetic steel plates through welding.

By fixing the general magnetic shield mentioned in the above on the inner wall of the tank in such a manner that the stacking direction of the plurality of magnetic steel plates constituting the magnetic shield is orthogonal to the direction along which the leakage flux will penetrate the tank, it is possible to prevent the leakage flux generated from the winding during a normal operation state from penetrating the inner wall of the tank. Here, the normal operation state refers to any operation state for a stationary induction device other than an abnormal operation state in which, for example, the winding is short-circuited and thereby the amount of leakage flux increases, and the magnetic shield is saturated by the leakage flux generated from the winding.

Owing to the magnetic shield, a path is formed for the leakage flux generated from the winding in the normal operation state to pass through the magnetic shield and return to the winding. Since the iron loss of the magnetic steel sheet is less than that of the material constituting the tank, the iron loss can be reduced by passing the leakage flux through the magnetic shield.

As described in the above, since each magnetic steel sheet is of a strip shape and has an insulating layer formed on both main surfaces, the eddy current generated by the magnetic flux penetrating the magnetic steel sheets from the side surface of the stacked magnetic steel sheets cannot spread in the stacking direction of the magnetic steel sheets. Therefore, in the normal operation state, the path for the eddy current generated in the magnetic shield is small, which makes it possible to reduce the eddy current loss through the magnetic shield.

However, as described in PTD 1, in the general magnetic shield of prior art, the adjacent magnetic shields are joined to each other through the plurality of retaining plates. Thus, in the case where the leakage flux generated from the winding in the abnormal operation state saturates the magnetic shield and penetrates the magnetic shield, the leakage flux passes through a loop section formed by the adjacent magnetic shields and the plurality of retaining plates, and generates an eddy current flowing in the loop section.

Specifically, since the pinching plates and the plurality of retaining plates for each magnetic shield are joined together through welding, they are electrically connected, constituting a loop section serving as a path across the plurality of magnetic shields for the eddy current. Since the eddy current will flow in a path where the interlinked magnetic flux is maximum, it is concentrated in the loop section.

The flux amount Φ of the leakage flux interlinking with the path of the eddy current and the eddy current amount I satisfy the relationship of dΦ/dt=V=RI, if the flux amount Φ of the leakage flux interlinking with the path of the eddy current and the electric resistance R of the path of the eddy current are determined, the eddy current I can be determined uniquely. As described in the above, since each of the pinching plates and the retaining plates is formed from a thin metal plate, the area of a cross section perpendicular to the flowing direction of the eddy current is small, and thereby, when the eddy current flows in the pinching plates and the retaining plates, the current density becomes large, which causes the pinching plates and the retaining plates to be overheated locally.

As described in the above, in the general magnetic shield of prior art, the magnetic shield is overheated locally by the eddy current flowing in the loop section under an abnormal operation state.

Further, in the general magnetic shield of prior art, in the case where the width of the magnetic steel sheet is narrowed for the purpose of making the magnetic shield thinner, the heat capacity of the magnetic steel sheet becomes smaller, and thereby in welding the magnetic steel sheets, joints may experience thermal expansion and cause distortions in the magnetic steel sheet. Accordingly, the plurality of magnetic steel plates may not be made into an integral unit. Thus, in the general magnetic shield of prior art, in order to ensure the heat capacity of the magnetic steel sheets, it is necessary to use the magnetic steel sheets each having a predetermined width or even wider, preventing the magnetic shield from being made thinner.

As illustrated in FIGS. 2 and 3, the stationary induction device according to the present embodiment is constructed in such a manner that the adjacent metal magnets 141 among the plurality of metal magnets 141 are joined to each other by one retaining plate only.

In the present embodiment, metal magnet 141 includes a plurality of magnetic steel sheets which are plate members stacked in direction 2 perpendicular to axial direction 1 of winding 120. The magnetic permeability of the magnetic steel sheets is higher than that of the structural rolled steel constituting tank 130. Each magnetic steel sheet has an outer shape of a strip, and each surface thereof is insulated through coating. The plurality of magnetic steel sheets are adhered together by an adhesive agent to form an integral unit. The cross-sectional shape of each metal magnet 141 is rectangular.

However, metal magnet 141 is not limited to the above configuration, for example, it may be formed from a twisted wire twisted from a wire member which is made of a material having a magnetic permeability higher than the structural rolled steel constituting tank 130, and the surface of the wire member is also insulated through coating. In the case of forming metal magnet 141 from a twisted wire, it is possible to integrate the plurality of wire members without using an adhesive agent. It should be noted that the twisted wire may be obtained by twisting one wire member which has been repeatedly folded.

The cross-sectional shape of metal magnet 141 is not limited to a rectangular shape, it may be a circular shape. In the case where the cross-sectional shape of metal magnet 141 is circular, compared to the case where the cross-sectional shape of metal magnet 141 is rectangular, due to the reason that no corner is present, it is possible to relax the electric field generated around metal magnet 141.

By insulating the surface of the plate member or the wire member through coating as described in the above, it is possible to insulate the adjacent plate members or the adjacent wire member. Thus, the eddy current is prevented from flowing between the adjacent plate members or the adjacent wire member, which makes it possible to reduce the path of the eddy current. As a result, it is possible to reduce the eddy current loss in metal magnet 141.

In addition, in order to reduce the eddy current loss in metal magnet 141, it is preferable for the plate member to have a thinner width, and it is preferable for the wire member to have a smaller diameter. Thereby, it is possible reduce the area of each plate member or each wire member to be penetrated by leakage flux 10, which makes it possible to reduce the path of the eddy current to be generated in each plate member or each wire member. As a result, it is possible to reduce the eddy current loss in metal magnet 141.

In the present embodiment as described in the above, first magnetic shield 140 is formed by fixing a plurality of metal magnets 141 extending in axial direction 1 of winding 120 on the inner wall of tank 130 side by side along direction 2 perpendicular to axial direction 1. The plurality of metal magnets 141 are joined respectively to first retaining plate 160 that is joined to the inner wall of tank 130, and thereby fixed on the inner wall of tank 130.

First retaining plate 160 has a rectangular shape longer in the longitudinal direction. First retaining plate 160 is fixed in such a manner that the longitudinal direction of first retaining plate 160 is parallel to direction 2 perpendicular to axial direction 1 of winding 120.

In first magnetic shield 140, six metal magnets 141 are fixed on the inner wall of tank 130 through five pieces of first retaining plates 160. In the present embodiment, metal magnet 141 and first retaining plate 160 are joined together through welding, they may be joined together through an adhesive agent.

Specifically, as illustrated in FIGS. 2 and 3, the first metal magnet 141 from the left and the second metal magnet 141 from the left are joined together by a single first retaining plate 160a. The first metal magnet 141 from the left and first retaining plate 160a are joined together at a joint 161a. The second metal magnet 141 from the left and first retaining plate 160a are joined together at a joint 162a.

The second metal magnet 141 from the left and the third metal magnet 141 from the left are joined together by a single first retaining plate 160b. The second metal magnet 141 from the left and first retaining plate 160b are joined together at a joint 162b. The third metal magnet 141 from the left and first retaining plate 160b are joined together at a joint 163b.

The third metal magnet 141 from the left and the fourth metal magnet 141 from the left are joined together by a single first retaining plate 160c. The third metal magnet 141 from the left and first retaining plate 160c are joined together at a joint 163c. The fourth metal magnet 141 from the left and first retaining plate 160b are joined together at a joint 164c.

The fourth metal magnet 141 from the left and the fifth metal magnet 141 from the left are joined together by a single first retaining plate 160d. The fourth metal magnet 141 from the left and first retaining plate 160d are joined together at a joint 164d. The fifth metal magnet 141 from the left and first retaining plate 160d are joined together at a joint 165d.

The fifth metal magnet 141 from the left and the sixth metal magnet 141 from the left are joined together by a single first retaining plate 160e. The fifth metal magnet 141 from the left and first retaining plate 160e are joined together at a joint 165e. The sixth metal magnet 141 from the left and first retaining plate 160e are joined together at a joint 166e.

The five pieces of first retaining plates 160 are disposed in axial direction 1 of winding 120 with a gap between each other. In the present embodiment, the five pieces of first retaining plates are disposed from one end of metal magnet 141 toward the other end thereof along axial direction 1 of winding 120 in order from first retaining plate 160a to first retaining plate 160e.

As described in the above, by preventing adjacent metal magnets 141 from being connected to each other through the plurality of retaining plates, it is possible to prevent a loop section from being formed between adjacent metal magnets 141 and the plurality of retaining plates.

Accordingly, in the case where first magnetic shield 140 is saturated by leakage flux 10 generated from winding 120 in the abnormal operating state and thereby leakage flux 10 penetrates first magnetic shield 140, since no loop section is present in first magnetic shield 140 as the path for the eddy current, it is possible to prevent the eddy current from being generated to flow in first magnetic shield 140. As a result, it is possible to prevent first magnetic shield 140 from being locally overheated by the eddy current flowing therein.

In the case where metal magnet 141 is composed of a twisted wire, in welding the wire member to the retaining plate, even if the joint experiences thermal expansion and cause distortions in the wire member, it is possible to maintain the plurality of twisted wire members as an integral unit. Therefore, compared to the case where metal magnet 141 is constructed from magnetic steel plates, it is possible to make the magnetic shield thinner.

It should be noted that the gap between adjacent metal magnets 141 is preferably smaller. By reducing the gap between adjacent metal magnets 141, it is possible to densely arrange the plurality of metal magnets 141 in first magnetic shield 140, which makes it possible to increase the area for leakage flux 10 to penetrate metal magnet 141.

The amount of leakage flux 10 passing through first magnetic shield 140 is determined by the ampere-turn of winding 120 and the structure of winding 120. The cross-sectional area of metal magnet 141 required by leakage flux 10 to pass through is determined by the saturation flux density of metal magnet 141. Thus, increasing the area for leakage flux 10 to penetrate metal magnet 141 allows metal magnet 141 to be made thinner while ensuring the required cross-sectional area of metal magnet 141, and consequently, it is possible to make first magnetic shield 140 thinner.

Hereinafter, a stationary induction device according to a second embodiment of the present invention will be described. The stationary induction device according to the present embodiment differs from stationary induction device 100 according to the first embodiment only in the numbers of the retaining plates, and thereby, the descriptions for the other components will not be repeated.

### Second Embodiment

FIG. 4 is a perspective view schematically illustrating a leakage flux penetrating a magnetic shield of the stationary induction device according to the second embodiment of the present invention. In FIG. 4, the magnetic shield is illustrated in a perspective view observed from the same direction as that in FIG. 3. The leakage flux illustrated in FIG. 4 is merely an example.

As illustrated in FIG. 4, in first magnetic shield 140 of the stationary induction device according to the second embodiment of the present invention, six metal magnets 141 are fixed on the inner wall of tank 130 through a single first retaining plate 260. In other words, three or more metal magnets 141 and first retaining plate 260 are joined together. First retaining plate 260 is disposed substantially at the center of metal magnet 141 in axial direction 1 of winding 120.

Specifically, in FIG. 4, the first metal magnet 141 from the left and the second metal magnet 141 from the left are joined together by first retaining plate 260 only. The first metal magnet 141 from the left and first retaining plate 260 are joined together at a joint 261. The second metal magnet 141 from the left and first retaining plate 260 are joined together at a joint 262.

The second metal magnet 141 from the left and the third metal magnet 141 from the left are joined together by first retaining plate 260 only. The third metal magnet 141 from the left and first retaining plate 260 are joined together at a joint 263. The third metal magnet 141 from the left and the fourth metal magnet 141 from the left are joined together by first retaining plate 260 only. The fourth metal magnet 141 from the left and first retaining plate 260 are joined together at a joint 264.

The fourth metal magnet 141 from the left and the fifth metal magnet 141 from the left are joined together by first retaining plate 260 only. The fifth metal magnet 141 from the left and first retaining plate 260 are joined together at a joint 265.

The fifth metal magnet 141 from the left and the sixth metal magnet 141 from the left are joined together by first retaining plate 260 only. The sixth metal magnet 141 from the left and first retaining plate 260 are joined together at a joint 266.

As described in the above, by preventing adjacent metal magnets 141 from being connected to each other through the plurality of retaining plates, it is possible to prevent a loop section from being formed between adjacent metal magnets 141 and the plurality of retaining plates.

Accordingly, in the case where first magnetic shield 140 is saturated by leakage flux 10 generated from winding 120 in the abnormal operating state and thereby leakage flux 10 penetrates first magnetic shield 140, since no loop section is present in first magnetic shield 140 as the path for the eddy current, it is possible to prevent the eddy current from being generated to flow in first magnetic shield 140. As a result, it is possible to prevent first magnetic shield 140 from being locally overheated by the eddy current flowing therein.

In the stationary induction device according to the present embodiment, compared to stationary induction device 100 according to the first embodiment, it is possible to reduce the number of the retaining plates and the number of joints between the retaining plate and the metal magnet. As a result, it is possible to simplify the structure of the stationary induction device, and thereby reduce the cost for fabricating the stationary induction device.

Hereinafter, a stationary induction device according to a third embodiment of the present invention will be described. The stationary induction device according to the present embodiment differs from stationary induction device 100 according to the first embodiment only in the numbers of the retaining plates and the arrangement of the retaining plates of the retaining plate, and thereby, the descriptions for the other components will not be repeated.

### Third Embodiment

FIG. 5 is an inner side view illustrating the configuration of a magnetic shield of the stationary induction device according to the third embodiment of the present invention. In FIG. 5, the magnetic shield is viewed from the same direction as that in FIG. 3.

As illustrated in FIG. 5, the stationary induction device according to the third embodiment of the present invention includes a plurality of first retaining plates. Some retaining plates in the plurality of the retaining plates are disposed closer to one end of metal magnets 141 in axial direction 1 of winding 120. Specifically, first retaining plate 360x, 360b, 360d and 360y are disposed closer to the upper end of metal magnet 141 in FIG. 5. In the present embodiment, first retaining plate 360x, 360b, 360d and 360y are disposed side by side along a straight line, but it is not limited thereto, and they may be shifted relative to each other.

The remaining retaining plates in the plurality of first retaining plates are disposed closer to the other end of metal magnets 141 in axial direction 1 of winding 120. Specifically, first retaining plates 360a, 360c and 360e are disposed closer to the lower end of metal magnet 141 in FIG. 5. In the present embodiment, first retaining plate 360a, 360c and 360e are disposed side by side along a straight line, but it is not limited thereto, and they may be shifted relative to each other.

One metal magnet 141 of the plurality of metal magnets 141 is connected to an adjacent metal magnet 141 which is positioned at one side relative to direction 2 perpendicular to axial direction 1 of winding 120 by a first retaining plate disposed closer to one end of the metal magnet 141, and is connected to another adjacent metal magnet 141 which is positioned at the other side relative to direction 2 perpendicular to axial direction 1 of winding 120 by a first retaining plate disposed closer to the other end of the metal magnet 141.

Specifically, as illustrated in FIG. 5, the first metal magnet 141 from the left and the second metal magnet 141 from the left are joined together by first retaining plate 360a. The first metal magnet 141 from the left and first retaining plate 360a are joined together at a joint 361a. The second metal magnet 141 from the left and first retaining plate 360a are joined together at a joint 362a. Further, the first metal magnet 141 from the left and first retaining plate 360x are joined together at a joint 361x.

The second metal magnet 141 from the left and the third metal magnet 141 from the left are joined together by first retaining plate 360b. The second metal magnet 141 from the left and first retaining plate 360b are joined together at a joint 362b. The third metal magnet 141 from the left and first retaining plate 360b are joined together at a joint 363b.

The third metal magnet 141 from the left and the fourth metal magnet 141 from the left are joined together by first retaining plate 360c. The third metal magnet 141 from the left and first retaining plate 360c are joined together at a joint 363c. The fourth metal magnet 141 from the left and first retaining plate 360c are joined together at a joint 364c.

The fourth metal magnet 141 from the left and the fifth metal magnet 141 from the left are joined together by first retaining plate 360d. The fourth metal magnet 141 from the left and first retaining plate 360d are joined together at a joint 364d. The fifth metal magnet 141 from the left and first retaining plate 360d are joined together at a joint 365d.

The fifth metal magnet 141 from the left and the sixth metal magnet 141 from the left are joined together by first retaining plate 360e. The fifth metal magnet 141 from the left and first retaining plate 360e are joined together at a joint 365e. The sixth metal magnet 141 from the left and first retaining plate 360e are joined together at a joint 366e. Further, the sixth metal magnet 141 from the left and first retaining plate 360y are joined together at a joint 366y.

As described in the above, by preventing adjacent metal magnets 141 from being connected to each other through the plurality of retaining plates, it is possible to prevent a loop section from being formed between adjacent metal magnets 141 and the plurality of retaining plates.

Accordingly, in the case where first magnetic shield 140 is saturated by leakage flux 10 generated from winding 120 in the abnormal operating state and thereby leakage flux 10 penetrates first magnetic shield 140, since no loop section is present in first magnetic shield 140 as the path for the eddy current, it is possible to prevent the eddy current from being generated to flow in first magnetic shield 140. As a result, it is possible to prevent first magnetic shield 140 from being locally overheated by the eddy current flowing therein.

In the stationary induction device according to the present embodiment, each metal magnet 141 are fixed on the inner wall of tank 130 at both ends by the retaining plate. Therefore, compared to the case where metal magnet 141 is fixed on the inner wall of tank 130 at only one end by the retaining plate, it is possible to reduce the distortion in each metal magnet 141 caused by an electromagnetic force which is generated from winding 120 when being energized and applied to each metal magnet 141.

Hereinafter, a stationary induction device according to a fourth embodiment of the present invention will be described. The stationary induction device according to the present embodiment differs from stationary induction device 100 according to the first embodiment only in that it further includes an insulator sandwiched between the metal magnets adjacent to each other, and thereby, the descriptions for the other components will not be repeated.

### Fourth Embodiment

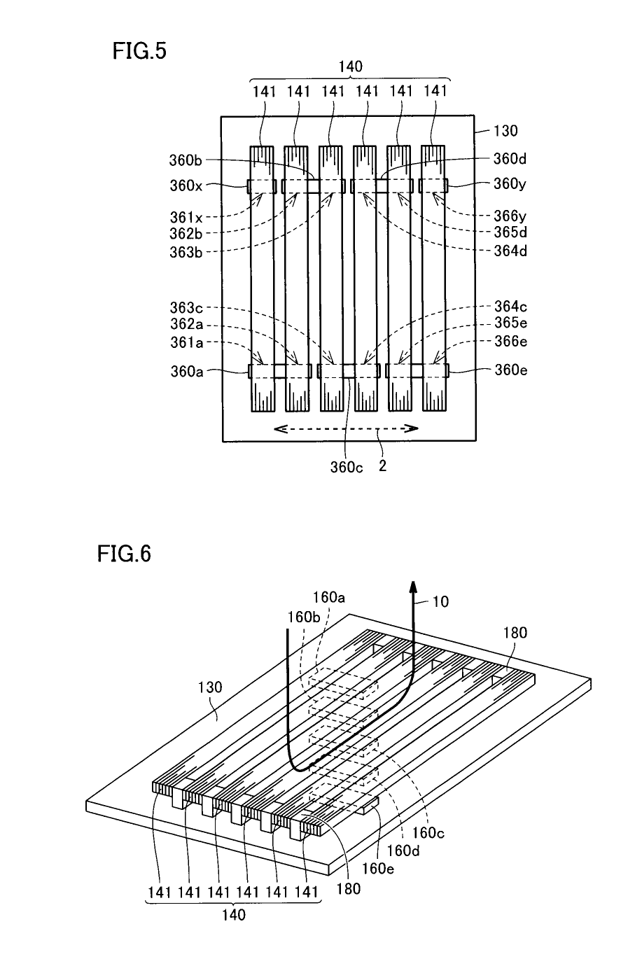

FIG. 6 is a perspective view schematically illustrating a leakage flux penetrating a magnetic shield of the stationary induction device according to the fourth embodiment of the present invention. In FIG. 6, the magnetic shield is illustrated in a perspective view observed from the same direction as that in FIG. 3. The leakage flux illustrated in FIG. 6 is merely an example.

As illustrated in FIG. 6, the stationary induction device according to the fourth embodiment of the present invention further includes an insulator 180 sandwiched between adjacent metal magnets 141. In the present embodiment, although insulator 180 is disposed at both ends to contact the side surface of metal magnet 141, the arrangement of insulator 180 is not limited thereto, for example, insulator 180 may be disposed at the center to contact the side surface metal magnet 141.

Insulator 180 may be formed from any material which has an electric insulating property and is resistant to insulating oil or insulating gas that is filled in tank 130, for example, a piece of insulating paper such as pressboard, resin, rubber, wood or ceramics. In addition, insulator 180 may be an insulating film which is formed by coating an insulating material on both side surfaces of metal magnet 141.

Owing to insulator 180, even in the case where the distortion is generated in metal magnets 141 in welding the same to the retaining plate, it is possible to prevent adjacent metal magnets 141 from contacting each other. Further, owing to insulator 180, it is possible to prevent adjacent metal magnets 141 from contacting each other due to the vibrations generated from core 110 and winding 120 when being energized. Accordingly, it is possible to prevent adjacent metal magnets 141 from contacting each other to make noise and prevent the path from being formed for the eddy current.

Hereinafter, a stationary induction device according to a fifth embodiment of the present invention will be described. The stationary induction device according to the present embodiment differs from the stationary induction device according to the fourth embodiment only in the shape of the insulator, and thereby, the descriptions for the other components will not be repeated.

### Fifth Embodiment

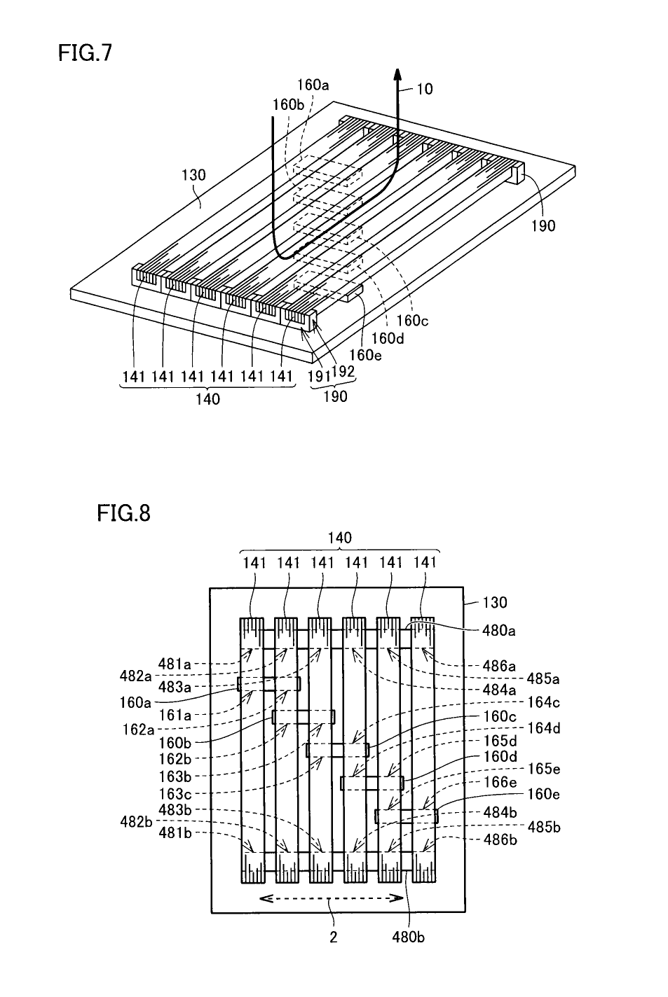

FIG. 7 is a perspective view schematically illustrating a leakage flux penetrating a magnetic shield of the stationary induction device according to the fifth embodiment of the present invention. In FIG. 7, the magnetic shield is illustrated in a perspective view observed from the same direction as that in FIG. 3. The leakage flux illustrated in FIG. 7 is merely an example.

As illustrated in FIG. 7, the stationary induction device according to the fifth embodiment of the present invention further includes an insulator 190 sandwiched between adjacent metal magnets 141. Insulator 190 is further sandwiched between the inner wall of tank 130 and metal magnet 141.

In the present embodiment, insulator 190 is configured to include a rectangular base portion 191 and two bent portions 192 bent from both ends of base portion 191 so as to be orthogonal to base portion 191. Insulator 190 is disposed in such a manner that metal magnet 141 is accommodated in a space surrounded by base portion 191 and two bent portions 192.

As a result, two bent portions 192 of adjacent insulators 190 are sandwiched between adjacent metal magnets 141 and contact each other. Base portion 191 of insulator 190 is sandwiched between the inner wall of tank 130 and metal magnet 141.

Insulator 190 may be formed from any material which has an electric insulating property and is resistant to insulating oil or insulating gas that is filled in tank 130, for example, a piece of insulating paper such as pressboard, resin, rubber, wood or ceramics.

Owing to insulator 190, even in the case where the distortion is generated in metal magnets 141 in welding the same to the retaining plate, it is possible to prevent adjacent metal magnets 141 from contacting each other. Further, owing to insulator 190, it is possible to prevent adjacent metal magnets 141 from contacting each other due to the vibrations generated from core 110 and winding 120 when being energized.

Similarly, owing to insulator 190, even in the case where the distortion is generated in metal magnets 141 in welding the same to the retaining plate, it is possible to prevent adjacent metal magnets 141 from bending toward the inner wall of tank 130. Further, owing to insulator 190, it is possible to prevent adjacent metal magnets 141 from contacting the inner wall of tank 130 due to the vibrations generated from core 110 and winding 120 when being energized.

Accordingly, it is possible to prevent adjacent metal magnets 141 from contacting each other to make noise and prevent the path from being formed for the eddy current. Furthermore, it is possible to prevent adjacent metal magnets 141 from contacting the inner wall of tank 130 to make noise and prevent the path from being formed for the eddy current.

Hereinafter, a stationary induction device according to a sixth embodiment of the present invention will be described. The stationary induction device according to the present embodiment differs from the stationary induction device according to the first embodiment only in that it further includes an insulator sandwiched between the metal magnets adjacent to each other, and thereby, the descriptions for the other components will not be repeated.

### Sixth Embodiment

FIG. 8 is a side view illustrating an inner structure of a magnetic shield for a stationary induction device according to the sixth embodiment of the present invention. In FIG. 8, the magnetic shield is illustrated in a perspective view observed from the same direction as that in FIG. 2.

As illustrated in FIG. 8, the stationary induction device according to the sixth embodiment of the present invention further includes an insulator sandwiched between the inner wall of tank 130 and metal magnets 141. In the present embodiment, the stationary induction device is provided with two insulators, namely an insulator 480a and an insulator 480b.

However, the number of the insulators is not limited to two, and may be one or even more. It is preferable that a plurality of insulators are provided since even though a plurality of insulators are provided, a new path will not formed for the eddy current, and the effect of suppressing the distortion of metal magnets 141 may be enhanced due to the disposition of a plurality of insulators.

Insulator 480a is disposed closer to one end of metal magnet 141 along axial direction 1 of winding 120. Specifically, insulator 480a is disposed closer to the upper end of metal magnet 141 in FIG. 8. Insulator 480a extends along direction 2 perpendicular to axial direction 1 of winding 120.

Insulator 480b is disposed closer to the other end of metal magnet 141 along axial direction 1 of winding 120. Specifically, insulator 480b is disposed closer to the lower end of metal magnet 141 in FIG. 8. Insulator 480b extends along direction 2 perpendicular to axial direction 1 of winding 120.

Insulator 480a and insulator 480b are joined to metal magnets 141 through an adhesive agent, but it is not necessary. However, joining insulator 480a and an insulator 480b to metal magnets 141 may prevent metal magnet 141 from distorting away from the inner wall of tank 130.

The first metal magnet 141 from the left and insulator 480a are joined together at a joint 481a. The second metal magnet 141 from the left and insulator 480a are joined together at a joint 482a. The third metal magnet 141 from the left and insulator 480a are joined together at a joint 483a. The fourth metal magnet 141 and insulator 480a are joined together at a joint 484a. The fifth metal magnet 141 from the left and insulator 480a are joined together at a joint 485a. The sixth metal magnet 141 from the left and insulator 480a are joined together at a joint 486a.

The first metal magnet 141 from the left and insulator 480b are joined together at a joint 481b. The first second metal magnet 141 from the left and insulator 480b are joined together at a joint 482b. The third metal magnet 141 from the left and insulator 480b are joined together at a joint 483b. The fourth metal magnet 141 from the left and insulator 480b are joined together at a joint 484b. The fifth metal magnet 141 from the left and insulator 480b are joined together at a joint 485b. The sixth metal magnet 141 from the left and insulator 480b are joined together at a joint 486b.

Insulator 480a and insulator 480b may be formed from any material which has an electric insulating property and is resistant to insulating oil or insulating gas that is filled in tank 130, for example, a piece of insulating paper such as pressboard, resin, rubber, wood or ceramics.

Owing to insulator 480a and insulator 480b, even in the case where the distortion is generated in metal magnets 141 in welding the same to the retaining plate, it is possible to prevent adjacent metal magnets 141 from bending toward the inner wall of tank 130. Further, owing to insulator 480a and insulator 480b, it is possible to prevent adjacent metal magnets 141 from contacting the inner wall of tank 130 due to the vibrations generated from core 110 and winding 120 when being energized.

Accordingly, it is possible to prevent adjacent metal magnets 141 from contacting the inner wall of tank 130 to make noise and prevent the path from being formed for the eddy current. It should be understood that the embodiments disclosed herein have been presented for the purpose of illustration and description but not limited in all aspects. It is intended that the scope of the present invention is not limited to the description above but defined by the scope of the claims and encompasses all modifications equivalent in meaning and scope to the claims.

### REFERENCE SIGNS LIST

10: leakage flux; 100: stationary induction device; 110: core; 111: magnetic steel sheet; 120: winding; 121, 141: metal magnet; 130: tank; 140: first magnetic shield; 150: second magnetic shield; 160, 160a, 160b, 160c, 160d, 160e, 260, 360a, 360b, 360c, 360d, 360e, 360x, 360y: first retaining plate; 161a, 162a, 162b, 163b, 163c, 164c, 164d, 165d, 165e, 166e, 261, 262, 263, 264, 265, 266, 361a, 361x, 362a, 362b, 363b, 363c, 364c, 364d, 365d, 365e, 366e, 366y, 481a, 481b, 482a, 482b, 483a, 483b, 484a, 484b, 485a, 485b, 486a, 486b: joint; 170: second retaining plate; 180, 190, 480a, 480b: insulator; 191: base portion; 192: bent portion

1. A stationary induction device comprising:
a tank;
a core which is housed in said tank;
a winding which is housed in said tank and wound around said core;
a plurality of metal magnets which are fixed on an inner wall of said tank and configured to form a magnetic shield for shielding a leakage flux generated from said winding; and
at least one retaining plate which is joined to said inner wall of said tank and said plurality of metal magnets so as to fix said plurality of metal magnets on said inner wall of said tank,
said plurality of metal magnets being fixed on said inner wall side by side with a gap between each other, and the metal magnets adjacent to each other being connected to each other by one retaining plate only.

2. The stationary induction device according to claim 1, wherein
said retaining plate has an outer shape of a strip longer in the longitudinal direction, and is fixed in such a manner that the longitudinal direction is parallel to a direction perpendicular to the axial direction of said winding.

3. The stationary induction device according to claim 1, wherein said retaining plate is joined to at least three of said metal magnets.

4. The stationary induction device according to claim 1, wherein
the stationary induction device includes a plurality of said retaining plates,
some retaining plates in the plurality of said retaining plates are disposed closer to one end of said metal magnet in the axial direction of said winding,
the remaining retaining plates in the plurality of said retaining plates are disposed closer to the other end of said metal magnet in the axial direction of said winding,
each metal magnet of said plurality of metal magnets is connected to an adjacent metal magnet of said plurality of metal magnets which is positioned at one side relative to the direction perpendicular to the axial direction by said retaining plate disposed closer to one end of said metal magnet, and is connected to another adjacent metal magnet of said plurality of metal magnets which is positioned at the other side relative to the direction perpendicular to the axial direction by said retaining plate disposed closer to the other end of said metal magnet.

5. The stationary induction device according to claim 1, further comprising an insulator sandwiched between said metal magnets adjacent to each other.

6. The stationary induction device according to claim 1, further comprising an insulator sandwiched between said inner wall of said tank and said metal magnet.

7. The stationary induction device according to claim 1, wherein
said metal magnet includes a plurality of plate members stacked in a direction perpendicular to the axial direction of said winding,
the material constituting said plate member has a magnetic permeability higher than the material constituting said tank.

8. The stationary induction device according to claim 7, wherein
said plate member is a magnetic steel sheet.

9. The stationary induction device according to claim 1, wherein said metal magnet includes a twisted wire twisted from a wire member made of a material having a magnetic permeability higher than the material constituting said tank.

10. The stationary induction device according to claim 7, wherein the surface of said plate member or said wire member is insulated through coating.
